(19) United States
(12) Patent Application Publication
(10) Pub. No.: US 2011/0321108 A1
(43) Pub. Date: Dec. 29, 2011

(54) METHOD AND SYSTEM FOR TELEVISION DISPLAY OF WEB FEED CONTENT

(75) Inventors: Darrin Wesley Harris, Fishers, IN (US); Michael D. Eastes, Greenfield, IN (US)

(73) Assignee: FEEDGAZER, LLC, Fishers, IN (US)

(21) Appl. No.: 13/256,192

(22) PCT Filed: Mar. 10, 2010
(86) PCT No.: PCT/US10/26877

§ 371 Date: Sep. 14, 2011

Related U.S. Application Data
(60) Provisional application No. 61/159,080, filed on Mar. 10, 2009.

(51) Int. Cl. H04N 7/173

(52) U.S. Cl. 725/110

(57) ABSTRACT

A system and method are described that provide television content broadcast system subscribers with convenient access to aggregated web feed content. In one embodiment, a television content broadcast system (20) maintains a database (21) linking one or more particular subscribers with one or more sources of web feed content. The television content broadcast system (20) downloads web feed content for a subscriber from the one or more sources associated with the subscriber, either at the user's request or to a cache (22). The television content broadcast system (20) sends the downloaded web feed content through a web content inter-face (30(2)) to a television receiver (41), or through a web content inter-face (30(3)) to a local memory (51) in a set-top box (50). In another embodiment, the television content broadcast subscribers also have accounts on a web content aggregation system (10). Web content aggregation system (10) retrieves web feed content associated with the user, and sends the web feed content to television content broadcast system (20) for forwarding to the appropriate subscriber.

### RELATED APPLICATION DATA

The present application claims priority to U.S. Provisional Application Ser. No. 61/159,080, filed on Mar. 10, 2009. It is also related to International Application No. PCT/US2007/068250 filed on May 4, 2007, and to U.S. Provisional Application Ser. No. 60/797,770 filed on May 4, 2006. The entireties of all of these documents are hereby incorporated by reference.

### FIELD

The present invention generally relates to web feed content aggregation systems of any web syndication type (e.g., RSS and Atom) and television content broadcast systems of any TV broadcasting type (e.g., cable and satellite). The present invention specifically relates to an interfacing between the web feed content aggregation system and the television content broadcast system to facilitate a television display of web feed content via an interactive feature of a television or set-top box, particularly an On-Demand feature or a widget.

### BACKGROUND

Web feed content is the textual/visual/aural content of any web syndication type including, but not limited to, web text content, web image content, web video content, web audio content and web animation content. A web feed content aggregation system is a system structurally configured on a web subscription account basis to retrieve syndicated web feed content (e.g., RSS, Atom and other XML formats) published by web servers.

Television content is the textual/visual/aural content of telecommunication systems including, but not limited to, TV text content, TV image content, TV video content, TV audio content and TV animation content. A television content broadcast system is a system structurally configured to receive and broadcast television content on a television subscription account basis.

### SUMMARY

One system described herein provides a web feed content interface for facilitating an exchange of web feed content from a web feed content aggregation system to television content broadcast system for purposes of a television display of the web feed content via an interactive feature of a television or a set-top box, particularly an On-Demand feature or a widget.

In one form, the web feed content aggregation system is operable to facilitate a user management of web feed content based on a web feed content aggregator subscription account of a user, and the television content broadcast system is operable to facilitate a user management of a display of television content based on a television content broadcast subscription account of the user. The web feed content interface of the present invention is established between the web feed content aggregation system and the television content broadcast system to facilitate an exchange of web feed content between the web feed content aggregation system and the television content broadcast system based on an account association of the user's web feed content aggregator subscription account and the television content broadcast subscription account whereby a television display of the web feed content can be managed by the user via an interactive feature of a television or a set-top box, particularly an On-Demand feature or a widget.

The web feed content aggregation system may include a library organized in a website genre tree format having root nodes branching to website nodes whereby each website node includes at least one website corresponding to the genre of the associated root node and whereby each website is listed with its web feeds. The web feed content aggregation system may include a plurality of web feed bulletins with each web feed bulletin providing a report of a single web feed item and with each web feed bulletin reporting a headline, a summary and/or an image associated with the single web feed item.

### BRIEF DESCRIPTION OF THE DRAWINGS

FIG. 1 illustrates one embodiment of a web feed content aggregation system, a television content broadcast system and a web feed content interface in accordance with the present invention;

FIG. 2 illustrates one embodiment of a television content broadcast system, a television and a web feed content interface in accordance with the present invention;

FIG. 3 illustrates one embodiment of a television content broadcast system, a set top box and a web feed content interface in accordance with the present invention; and

FIGS. 4A and 4B illustrate a first exemplary embodiment and a second exemplary embodiment of FIGS. 1-3 in accordance with the present invention;

FIG. 5 illustrates a third exemplary embodiment of FIGS. 1-3 in accordance with the present invention;

FIG. 6 illustrates a fourth exemplary embodiment of FIGS. 1-3 in accordance with the present invention;

FIG. 7 illustrates a fifth exemplary embodiment of FIGS. 1-3 in accordance with the present invention;

FIG. 8 illustrates an exemplary embodiment of servers illustrated in FIG. 7 in accordance with the present invention;

FIG. 9 illustrates an exemplary website content genre tree in accordance with the present invention;

FIG. 10 illustrates an exemplary library page in accordance with the present invention;

FIG. 11 illustrates an exemplary media root node in accordance with the present invention;

FIG. 12 illustrates an exemplary navigation within the media root node illustrated in FIG. 11 in accordance with the present invention;

FIG. 13 illustrates an exemplary government/political root node in accordance with the present invention;

FIG. 14 illustrates an exemplary education/training root node in accordance with the present invention;

FIG. 15 illustrates an exemplary consumer root node in accordance with the present invention;

FIG. 16 illustrates an exemplary sports root node in accordance with the present invention;

FIG. 17 illustrates an exemplary business/financial root node in accordance with the present invention;

FIG. 18 illustrates an exemplary entertainment root node in accordance with the present invention;

FIG. 19 illustrates an exemplary science/technology root node in accordance with the present invention;

FIG. 20 illustrates an exemplary health root node in accordance with the present invention;

FIG. 21 illustrates an exemplary special interest root node in accordance with the present invention;

FIGS. 22 and 23 illustrate an exemplary embodiment of a web feed bulletin in accordance with the present invention;

FIG. 24 illustrates an exemplary RSS display synchronization in accordance with the present invention; and

FIG. 25 illustrates one embodiment of an ad revenue model in accordance with the present invention.

### DETAILED DESCRIPTION

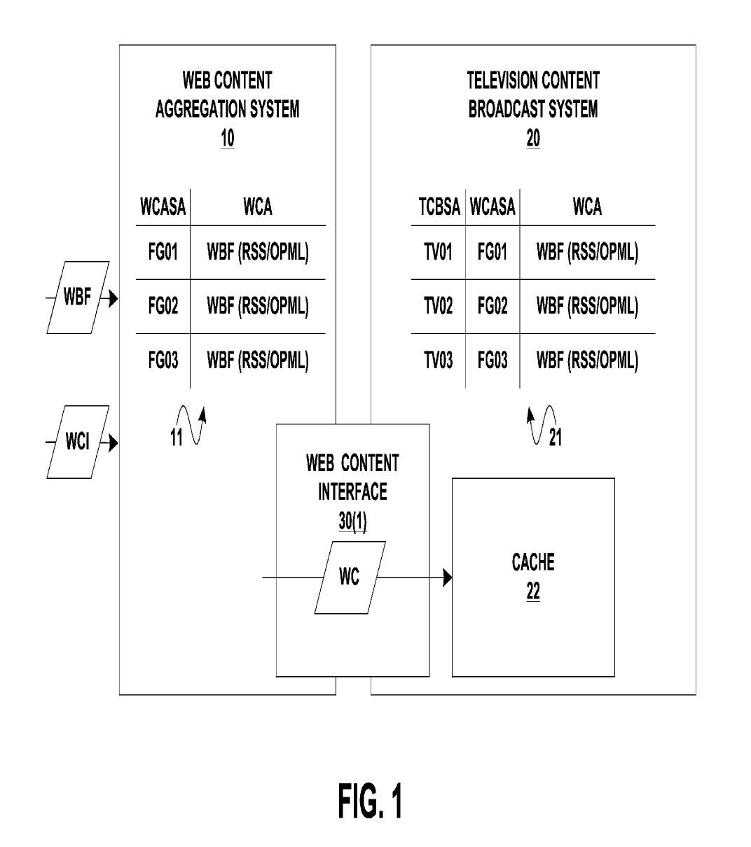

FIG. 1 illustrates a web feed content aggregation system 10 structurally configured on a web subscription account basis to retrieve syndicated web feed content of any format (e.g., RSS, Atom and other XML formats) published by any type of web server. Commercial examples of web feed content aggregation system 10 include, but are not limited to, (1) www.feedgazer.com; (2) www.google.com/reader; (3) my.yahoo.com; (4) www.pluck.com; (5) www.newsgator.com; (6) www.rojo.com; (7) www.bloglines.com; (8) www.feedlounge.com; (9) www.netvibes.com; (10) www.newsfirerss.com; (11) www.rrsowl.com; (12) www.rrsexpress.net; (13) www.mozilla.com/en-US/firefox/; (14) www.rssfwd.com/; (15) www.raggle.org/; and (16) www.planetplanet.org/.

While any of the current and future web feed content aggregation systems may be employed in accordance with the inventive principles of the present invention, www.feedgazer.com is currently preferred in view of its capability to enable a user with a management of individual web feeds of any type based on a web feed content aggregation subscription account established by www.feedgazer.com on behalf of the user and to read in lists of web feeds of any type from additional web feed content aggregation subscription accounts established by third party web feed content aggregation systems on behalf of the user. As such, web feed content aggregation system 10 is shown in FIG. 1 as receiving web feed content WFC for populating a table 11 representing a web feed content aggregation WFCA of web feed content WFC on a web feed content aggregation subscription account WFCASA basis, of which web feed content aggregation subscription accounts FG01, FG02 and FG03 of www.feedgazer.com are shown. As previously described, web feed content WFC can either be directly subscribed by the user via www.feedgazer.com (“RSS”) and/or indirectly subscribed by the user via one or more third party web feed content aggregation systems (“OPML”).

FIG. 1 further illustrates a television content broadcast system 20 structurally configured to receive and broadcast television content on a user subscription account basis. Commercial examples of television content broadcast system 20 include, but are not limited to, cable television providers such as (1) Insight Communications; (2) Comast; (3) Adelphia; (4) Austar; (5) Bright House Networks; (6) CableOne; (7) Cable TV Hong Kong; (8) Cablevision (US); (9) Cablevision (Canada); (10) Canal Digital; (11) Charter; (12) Champion Broadband; (13) Cogeco; (14) Columbus Communications; (15) Com Hem; (16) Cox; (17) Eastlink; (18) Foxtel; (19) GCI; (20) Global Destiny; (21) Globosat; (22) Kabel Deutschland; (23) Knology; (24) MASTV; (25) MCV Broadband; (26) Mediacom; (27) Midcontinent Communications; (28) Millennium Digital Media; (29) Neighbourhood Cable; (30) Net Brasil; (31) NTL; (32) Ono; (33) Optus; (34) Persona; (35) RCN; (36) Rogers; (37) Satview Broadband Ltd; (38) Service Electric; (39) SkyCable; (40) Shaw; (41) StarHub CableTV; (42) Suddenlink; (43) TDC; (44) Tele2; (45) TelstraClear InHomeTV; (46) Time Warner; (47) TransACT; (48) TV Cabo; (49) Vidéotron; (50) Virgin Media; (51) WOW! Internet Cable Phone; and (52) WightCable.

Further commercial examples of television content broadcast system 20 include, but are not limited to, satellite television providers such as (1) AlphaStar; (2) ART; (3) Astro; (4) Astro Nusantara; (5) Athina Sat; (6) Austar; (7) Bell ExpressVu; (8) Canal Digital; (9) CanalSat; (10) Cyfra+; (11) DialogTV; (12) Digital+; (13) Digiturk; (14) DirecTV; (15) Dish Network| Dish TV; (16) DStv; (17) Euro1080; (18) Freesat; (19) Freesat from Sky; (20) FreeView (NZ); (21) Foxtel; (22) GlobeCast World TV; (23) Globosat; (24) Glorystar; (25) Home2US; (26) NTV Plus; (27) NOVA Cyprus; (28) NOVA Greece; (29) Orbit; (30) Premiere; (31) PrimeStar; (32) SelecTV; (33) Showtime Arabia; (34) Sky Angel; (35) Sky Digital; (36) SKY Italia; (37) Sky PerfecTV!; (38) Sky TV (NZ); (39) Star Choice; (40) STAR TV; (41) Tata Sky; (42) TPS; (43) TV Cabo; (44) UBI World TV; (45) Viasat; (46) Voom; and (47) WOWOW.

While any of the current and future television content broadcast systems may be employed in accordance with the inventive principles of the present invention, such systems having or capable of having an interactive feature (e.g., On Demand or a widget) are preferred in view of the ease and convenience a user would have in managing a television display of web feed content based on a remote control of these features as known in the art.

FIG. 1 further illustrates a web feed content interface 30(1) structurally configured to exchange web feed content WFC between web feed content aggregation system 10 and television content broadcast system 20 based on an account association of each web feed content aggregator subscription account (“WFCASA”) of system 10 to a television content broadcast subscription account (“TCBSA”) of system 20 as represented by a table 21, in which television content broadcast subscription accounts TV01, TV02 and TV03 for example are shown associated with respective web feed content aggregator subscription accounts FG01, FG02 and FG03 of www.feedgazer.com for example.

In view of the numerous and variety of possible commercial implementations of systems 10 and 20 in practice, the present invention does not impose any limitations nor any restrictions as to the manner by which web feed content interface 30(1) is structurally configured to exchange and format web feed content WFC between systems 10 and 20.

In one embodiment, web feed content interface 30(1) is structurally configured as a database manager of any type operable to exchange web feed content WFC between systems 10 and 20 in a format suitable for the transmission for the world wide web. Alternatively or concurrently, web feed content interface 30(1) is structurally configured as a database manager of any type operable to exchange web feed content WFC between systems 10 and 20 in a format suitable for the broadcast of the web feed content WFC in a television content format. For either embodiment, television content broadcast system 20 preferably, although not required, employs a cache 22 for storing a portion or an entirety of web feed content WFC for each individual television content broadcast subscription account TCBSA.

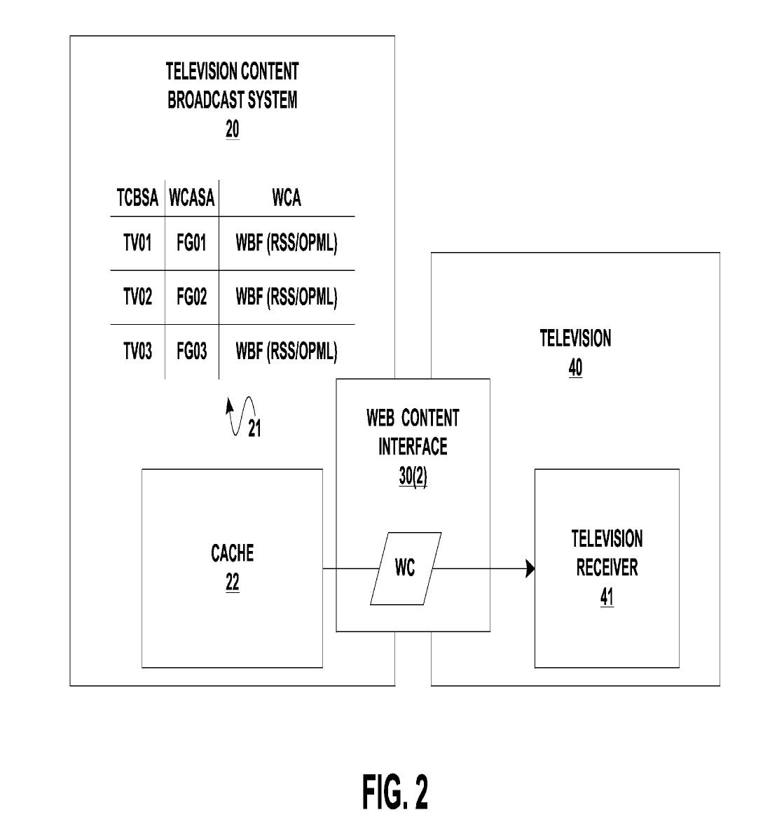

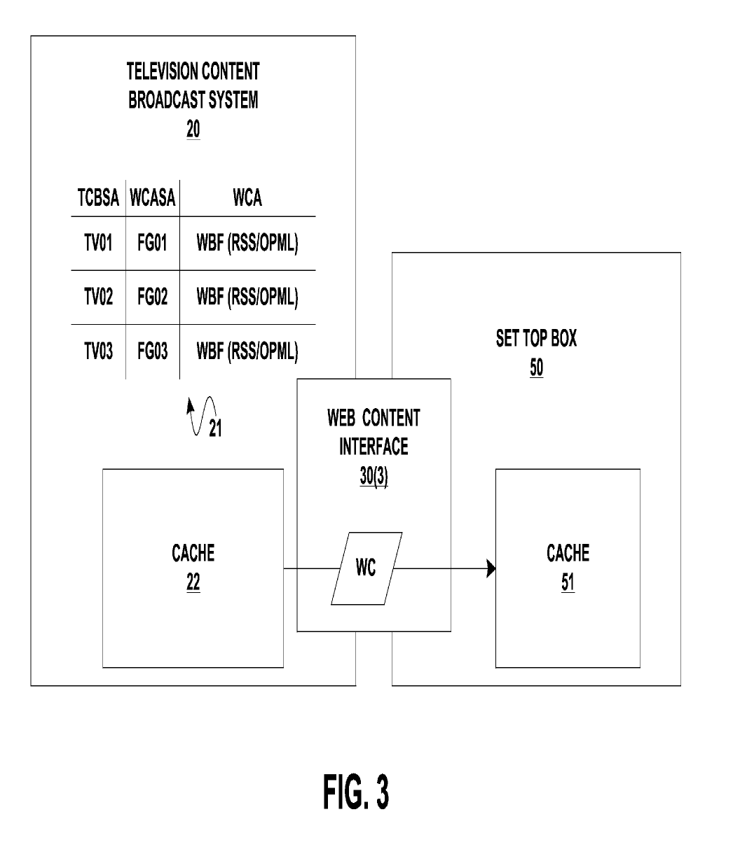

Web feed content interface 30(1) is considered a front end interface. To further enable television display of the web feed content WFC that is managed by a user of a television content broadcast subscription account TCBSA, a back end web feed content interface 30(2) is structurally configured to exchange web feed content WFC between television content broadcast system 20 and either a television 40 via its television receiver 41 (e.g., a cable or Internet based receiver) as shown in FIG. 2 or a set top box 50 via a cache 51 as shown in FIG. 3. In either case, in view of the numerous and variety of possible commercial implementations of system 20, television 40 and set top box 50 in practice, the present invention does not impose any limitations nor any restrictions as to the manner by which web feed content interface 30(2) is structurally configured to exchange and format web feed content WFC between system 20 and television 40 and between system 20 and set top box 50.

In one embodiment, web feed content interface 30(2) is structurally configured as an interactive feed manager (e.g., On-Demand or a widget) operable to enable a user of the television content broadcast subscription account TCBSA to control a display of the web feed content WFC via a remote control whereby television content broadcast system 20 is responsive to remote control commands to provide the web feed content WFC interactively in either a world wide web format and/or in a television content format to television receiver 41 or to set top box 50 based on the account association.

In practice, the structural configurations of interfaces 30 is within the skill of those having ordinary skill in the art of web and television formatting and communication protocols, particularly those having skill in database management, video on demand and widget programming.

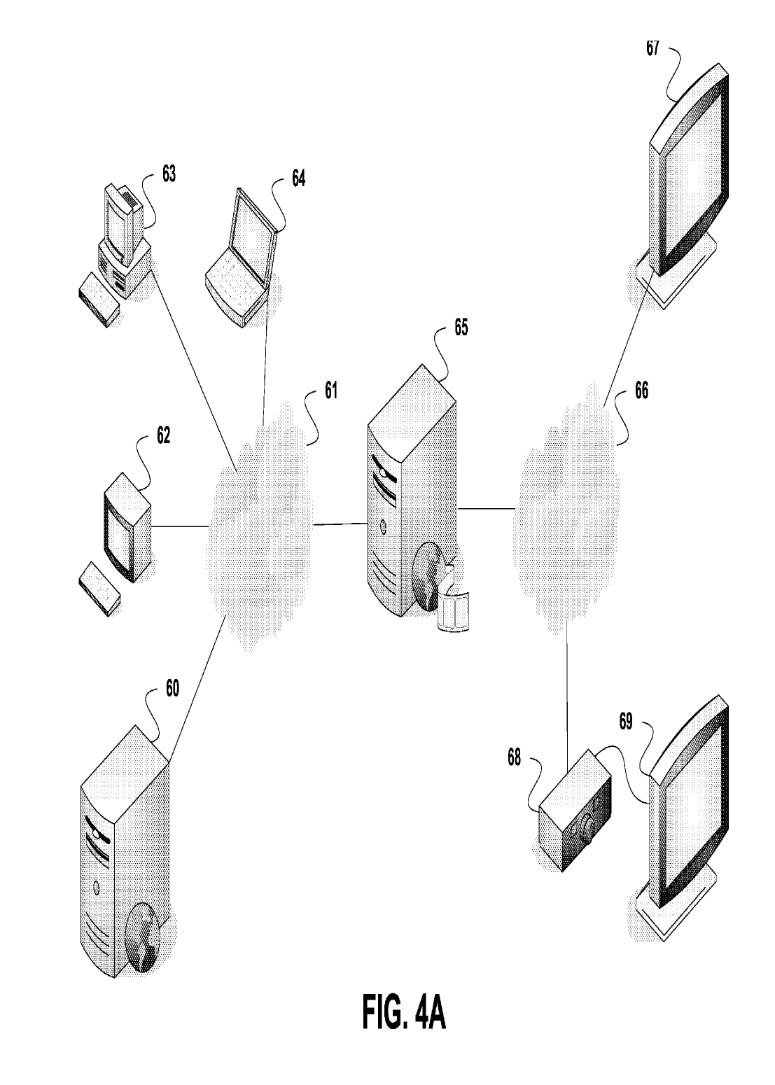

FIG. 4A illustrates an exemplary embodiment of FIGS. 1-3 with a web server 60 serving as web feed content aggregation system 10 (FIG. 1) and a streaming/downloading media server 65 serving as a feed on demand component of television content broadcast system 20 (FIGS. 1-3). A user can utilize a PC 63, a workstation 64, a laptop 65 or the like to manage a retrieval of web feed content WFC by server 60 via an internet network 61 of any type from other web servers (not shown) based on the user's web feed content aggregation subscription account WFCASA (e.g., account FG01 of FIGS. 1-3). Front end web feed content interface 30(1) (FIG. 1) is installed in server 60, installed in server 65 or distributed among servers 60 and 65 to provide web feed content WFC retrieved by server 60 to server 65 on a web feed content aggregation subscription account basis WFCASA.

Back end web feed content interface 30(2) (FIGS. 2 and 3) is installed in server 65, installed in a television 67 and a set top box 68, or distributed among server 65, television 67 and set top box 68 to provide the web feed content WFC received by server 65 via a telecommunications network 66 of any type in either a world wide web format and/or in a television content format to television 67 or a television 69 via set top box 68 based on an account association of the user's web feed content aggregation subscription account WFCASA (e.g., account FG01 of FIGS. 1-3) and television content broadcast subscription account TCBSA (e.g., account TV01 of FIGS. 1-3).

FIG. 4B illustrates an alternative embodiment of FIG. 4A with web server 60 being connected via an intranet network 70 of any type to streaming/downloading media server 65.

Referring to FIGS. 4A and 4B, servers 60 and 65 can represent an actual physical implementation of the present invention or a logical domain representation of the present invention. Furthermore, a video on demand system can be integrated in server 65 with a feed on demand system in accordance with the present invention via a hard or soft switch. Commercial examples of video on demand system include, but are not limited to, Akimbo, iN Demand and SeaChange International.

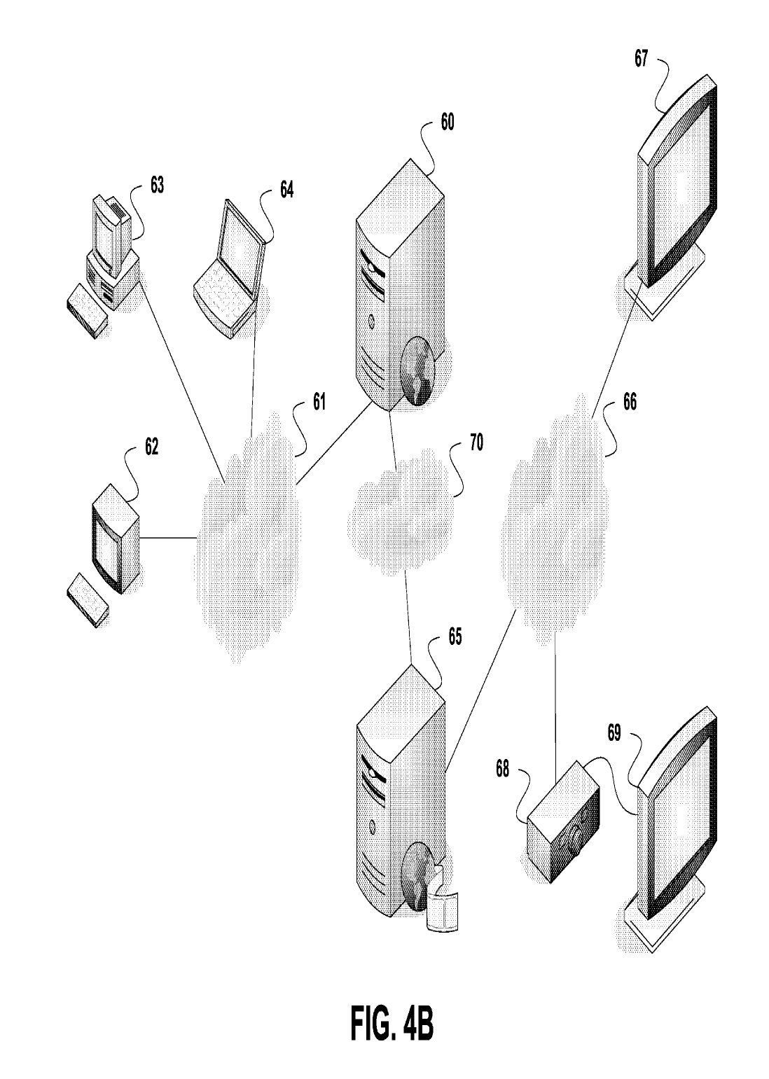

For example, FIG. 5 illustrates a logical domain 80 having a web feed content aggregation system (not shown) and a television content broadcast system (not shown) that facilitates an access management via an internet 85 of web feed content (e.g., subscribed RSS feeds) and targeted advertisements via a web client 87 for purposes of allowing an On-Demand display of web feed content on a television 88 and targeted advertisements via a cable/satellite television network 86. To this end, the content systems of domain 80 employ a database management of a web feed content catalog 81 and a targeted advertisement inventory 82 as a function of an account association of a web feed aggregator account directory 83 and a cable/satellite television account directory 84.

Specifically, web feed content catalog 81 encompasses a web feed directory table and a table for each web feed on a syndicated feed item basis. The web feed directory table is designed on a feed category basis whereby the web feed directory table is updated upon the discovery of a new web feed source fitting within a category and a table for a particular listed web feed is updated each time a listed web feed syndicates a new web feed item.

Targeted advertisement inventory 82 encompasses an advertisement directory table and a table for each subscriber of domain 80 on a solicited targeted basis. Thus, any advertisement installed in domain 80 (e.g., uploaded, downloaded or streamed) is tracked in the directory table and communicated to each subscriber for purposes of facilitating a selection of viewing the advertisement by each subscriber on a item or category basis.

Web feed aggregator account directory 83 and cable/satellite television account directory 84 encompass a listing of each subscriber to domain 80 for purposes of facilitating a viewing of subscripted web feed content via client 87 or television 88, respectively. The account association of each directory 83 and 84 enables the viewing to be accomplished in a cooperative manner between the content systems that monitors when and where each feed items has been viewed by each subscriber, saves viewed feed items at the discretion of a subscriber and further dynamically updates the viewing of feed items based on any change in a web feed subscription by a subscriber.

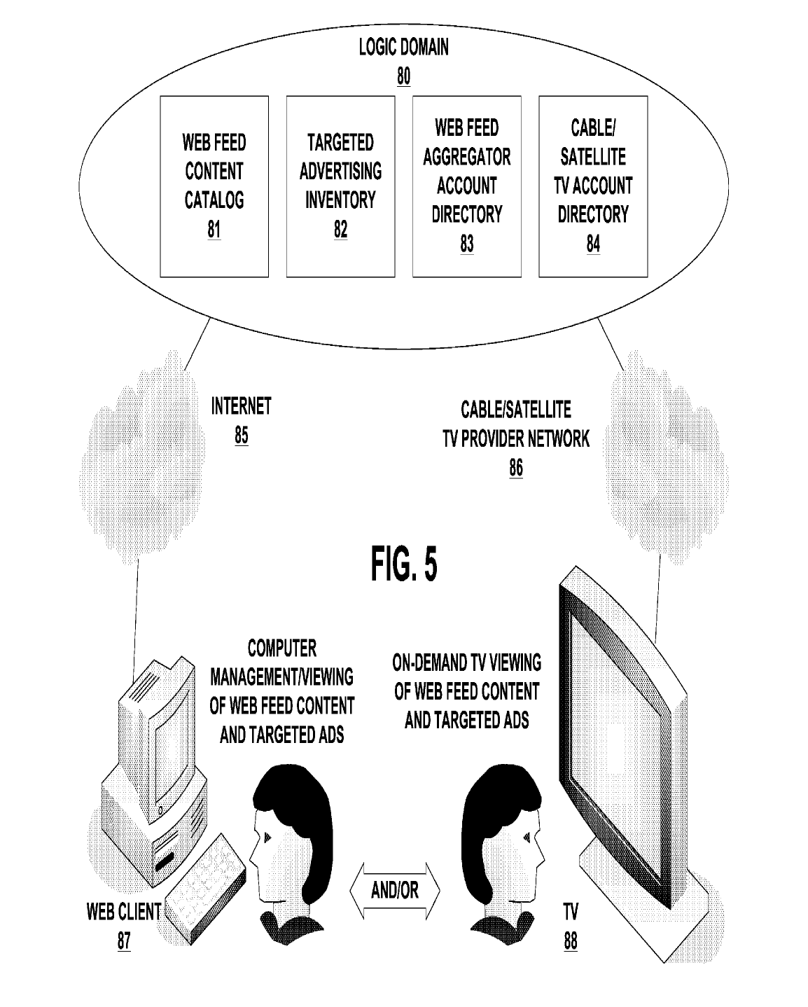

FIG. 6 illustrates an account association of a web subscription account 91 of a web feed content (“WFC”) aggregation system 90 with a television subscription account 101 of a digital receiver 100 of a television feed content (“TFC”) system. This account association enables a viewer to either (1) view web feed content in web format from an aggregator library 92 via the Internet 110 or (2) view the web feed content in TV format from the aggregator library 110 via a cable/satellite network 111 or alternatively the Internet 110. In the case of an Internet viewing of the web feed content, a web client 120 is used to access the aggregator library 92 as currently practiced today with known aggregators. In the case of a cable/satellite TV viewing of the web feed content, a remote control of the digital receiver 100 is used to activate an interactive feature 102 of the digital receiver 100 (e.g., an On-Demand feature or a widget) to access the aggregator library 92. The aggregator library 92 is a library of websites having web feed content that is organized in a hierarchy that facilitates a viewer management of a personal portfolio of such websites selected from the aggregator library 92. The hierarchy has a public version designed on a website genre tree for viewers having minimal, if any, experience with websites having web feed content. The hierarchy further has one or more private versions generated on behalf of viewers on a feed category basis or a website genre tree having extensive experience with websites having web feed content. Additionally, system 90 synchronizes viewing between the Internet and cable/satellite viewing channels 110/111 to ensure new web feed content is being presented at each viewing and provides a chronicle service for storing links to the web feed content.

For purposes of the present invention, the term “feed category basis” is broadly defined herein as any group listing of individual web feeds on the basis of a categorization of the web feeds as opposed to a genre of the associated websites. Examples include, but are not limited to, a football folder listing of all football feed subscriptions irrespective of the genre of the associated websites or a financial folder listing all financial feed subscriptions irrespective of the genre of the associated website.

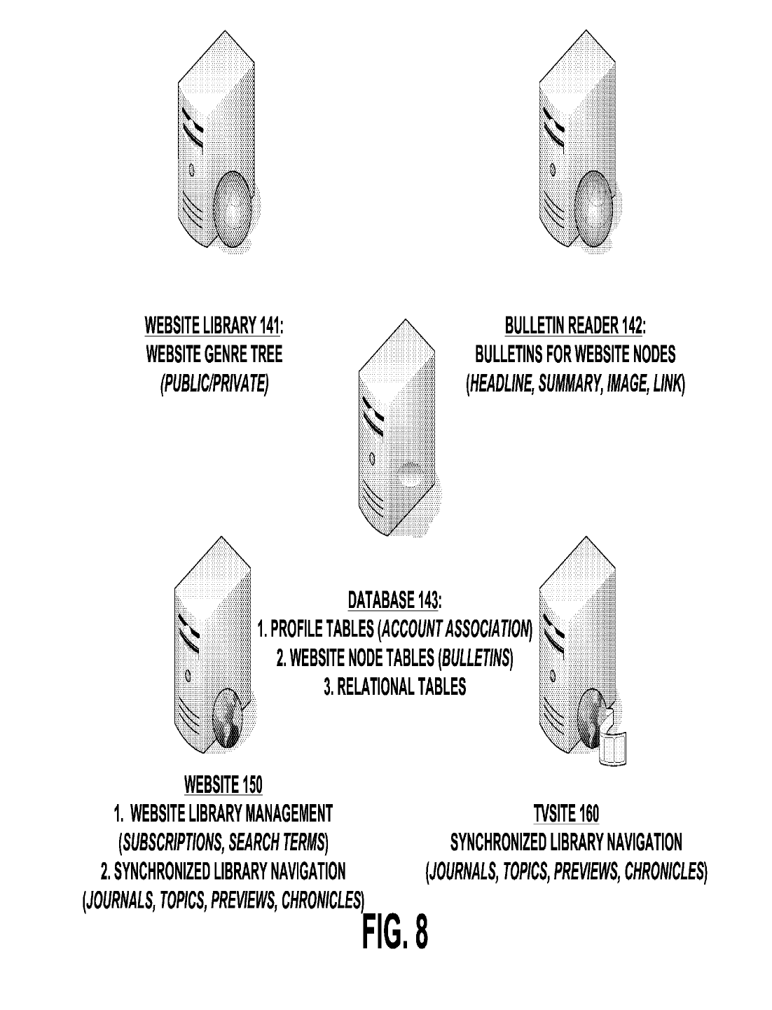

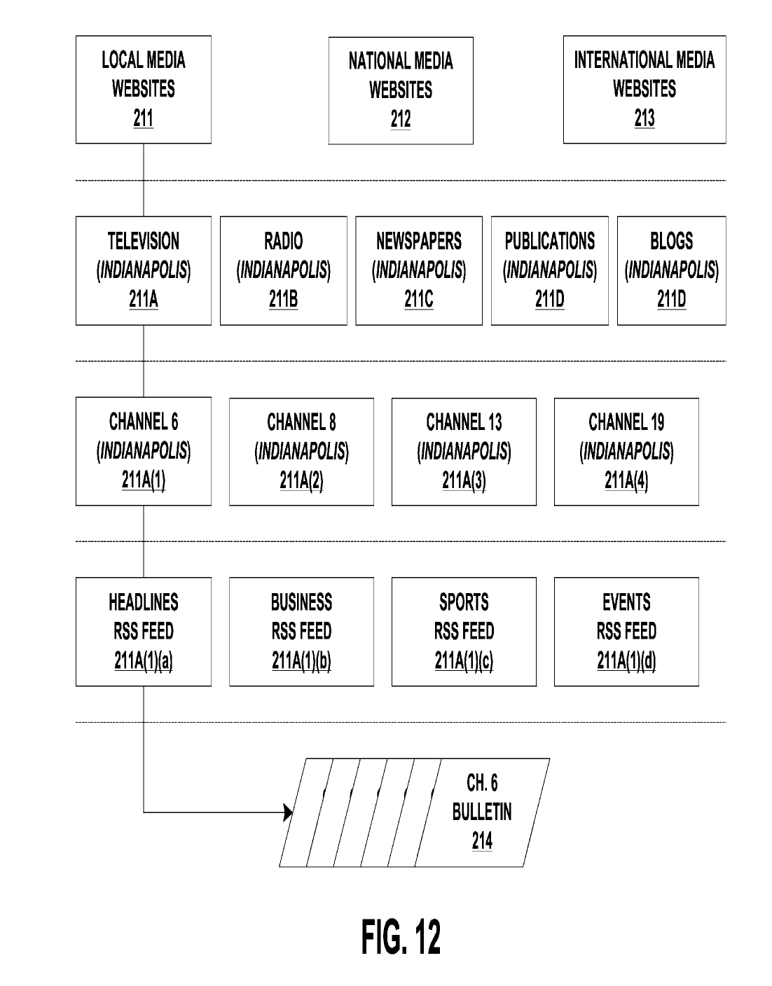

By comparison, for purposes of the present invention, the term “web genre tree” is broadly defined herein as having root nodes branching to one or more website nodes, with each website node listing one or more individual websites on the basis of a genre of the corresponding root node and with each listed website listing all of its associated web feeds. Examples will be provided subsequently herein in connection with the description of FIGS. 9-21.

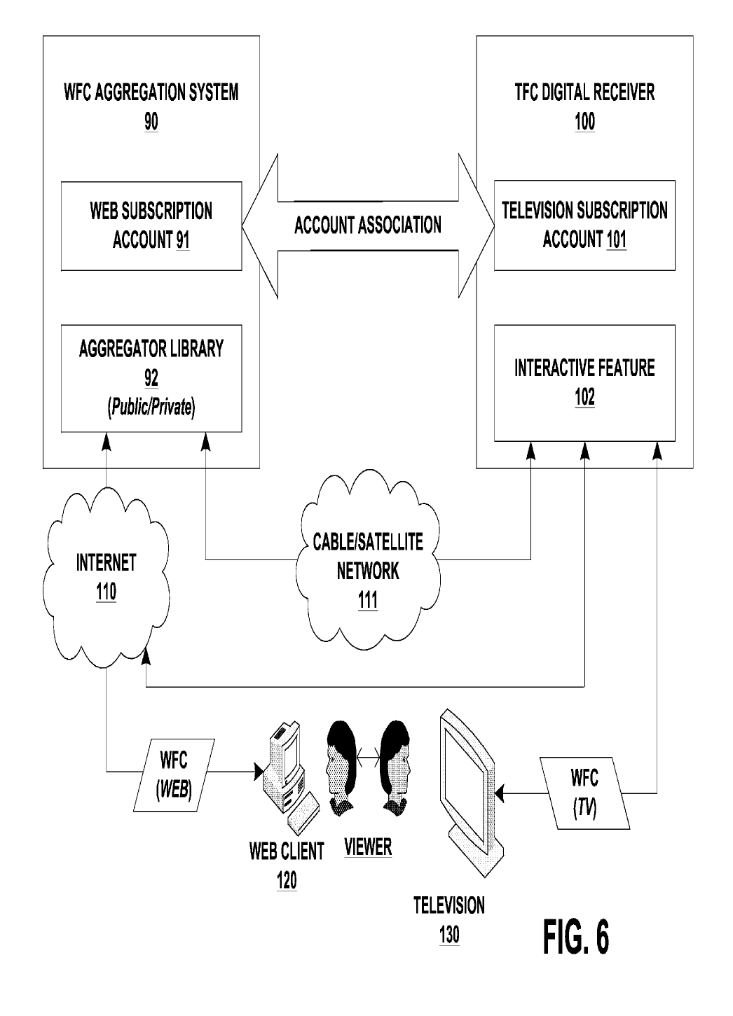

FIG. 7 illustrates a commercial incorporation of the aggregator system into an interactive feature of a cable/satellite television provider. As shown FIG. 7, a web content aggregation system 140 employs a website library 141, a bulletin reader 142 and a database 143 for managing and displaying a vast number of web feeds on behalf of the subscribers of the cable/satellite television provider as well as non-subscribers. Specifically, a website 150 will facilitate subscriber/non-subscriber access to system 140 via the internet 110 whereby banner/video advertising from a web ad server 151 will generate ad revenue from the subscribers as well as non-subscribers accessing website 140. A TVsite 160 will facilitate viewer access to system 140 via the cable/satellite network 111 or alternatively internet 110 whereby banner/video advertising from a TV Ad Server 161 will generate ad revenue from the subscribers. Optionally, a promotion server or servers (not shown) may substitute for and/or supplement ad server 151 and/or ad server 161 to provide promotion of various websites to the subscribers as well as nonsubscribers.

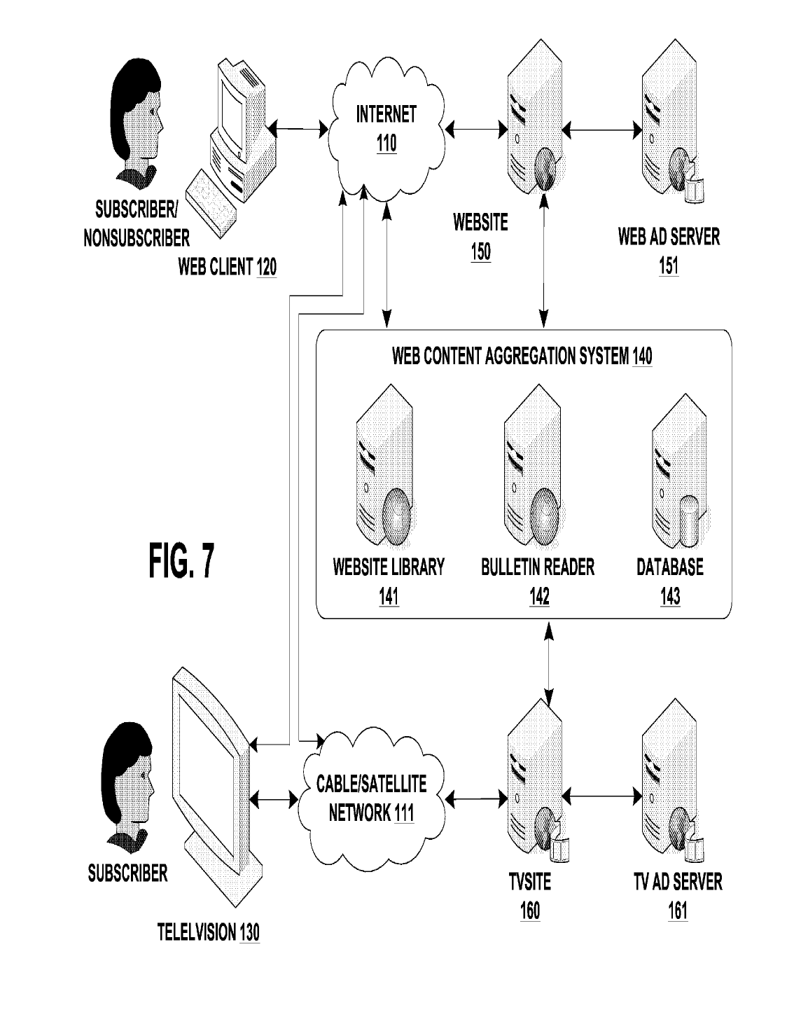

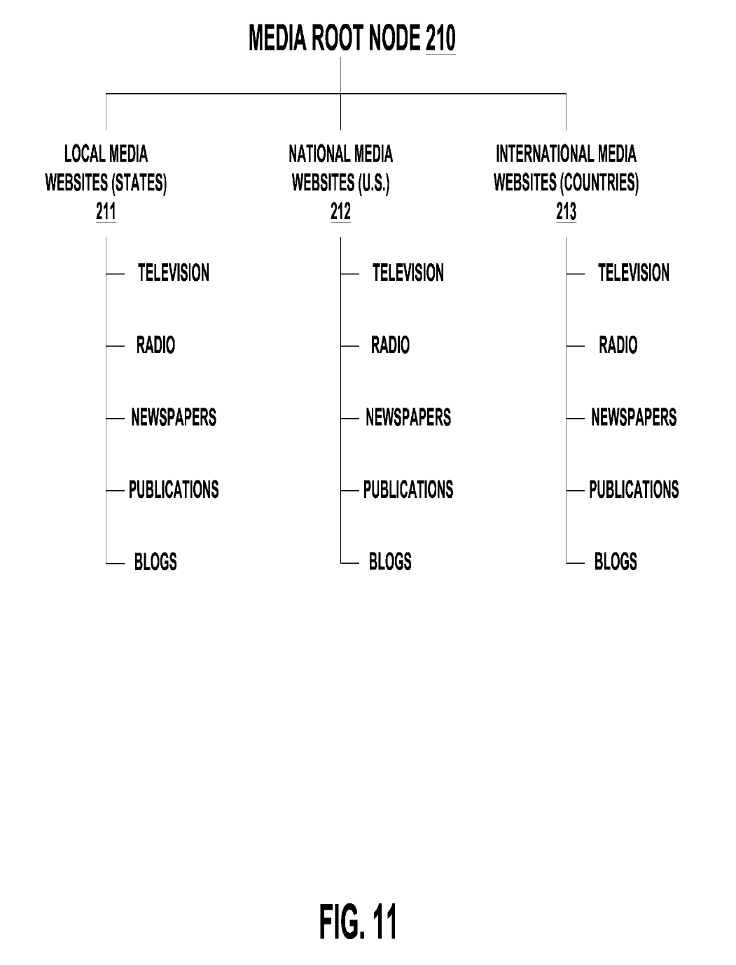

FIG. 8 illustrates servers 141-143, 150 and 160 in more detail. Specifically, web library server 141 is structurally configured with a web genre tree, such as, for example, a web genre tree 200 shown in FIG. 9. Web genre tree has twelve (12) root nodes 210-330. A media root node 210 lists all websites primarily designed for the reporting of a variety of news subjects (e.g., television, radio, newspapers, and publications) and may be further branched into local websites node 211, national websites node 212 and international websites node 213 as shown in FIG. 11.

A media root node 210 lists all websites primarily designed for the reporting of a variety of information from various sources (e.g., television, radio, newspapers, publications, blogs) and may be further branched into local websites node 211, national websites node 212 and international websites node 213 as shown in FIG. 11. An example includes, but is not limited to, www.cnn.com listed under television for national website node 212.

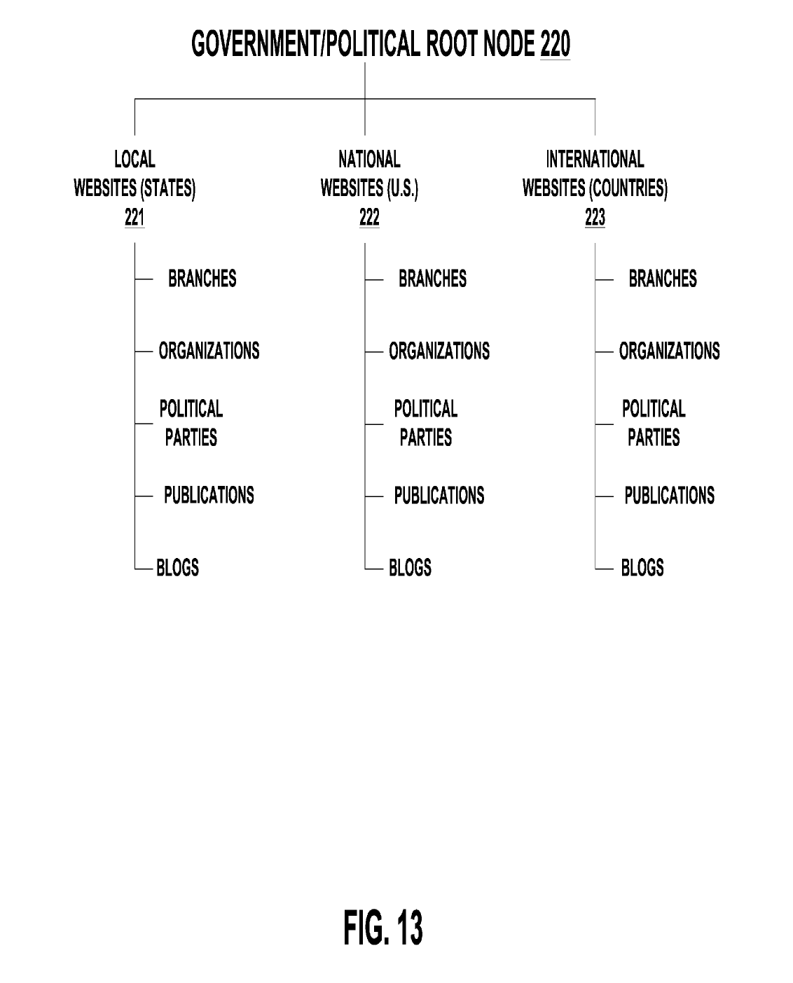

A government/political root node 220 lists all websites primarily designed for the reporting of political information from various sources (e.g., government branches, organizations, political parties, publications, and blogs) and may be further branched into local websites node 221, national websites node 222 and international websites node 213 as shown in FIG. 13. An example includes, but is not limited to, www.whitehouse.gov listed under branches for national website node 222.

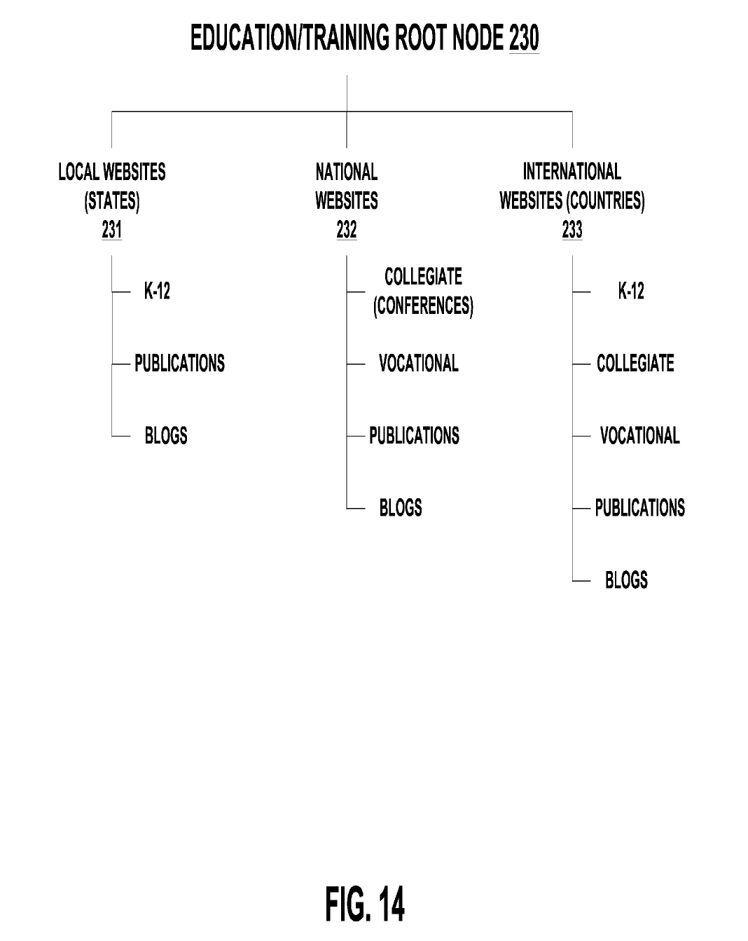

An educational/training root node 230 lists all websites primarily designed for the reporting of educational/training information from various sources (e.g., K-12, collegiate, vocational, publications, blogs) and may be further branched into local websites node 231, national websites node 232 and international websites node 233 as shown in FIG. 14. An example includes, but is not limited to, www.purdue.edu listed under collegiate for national website node 232.

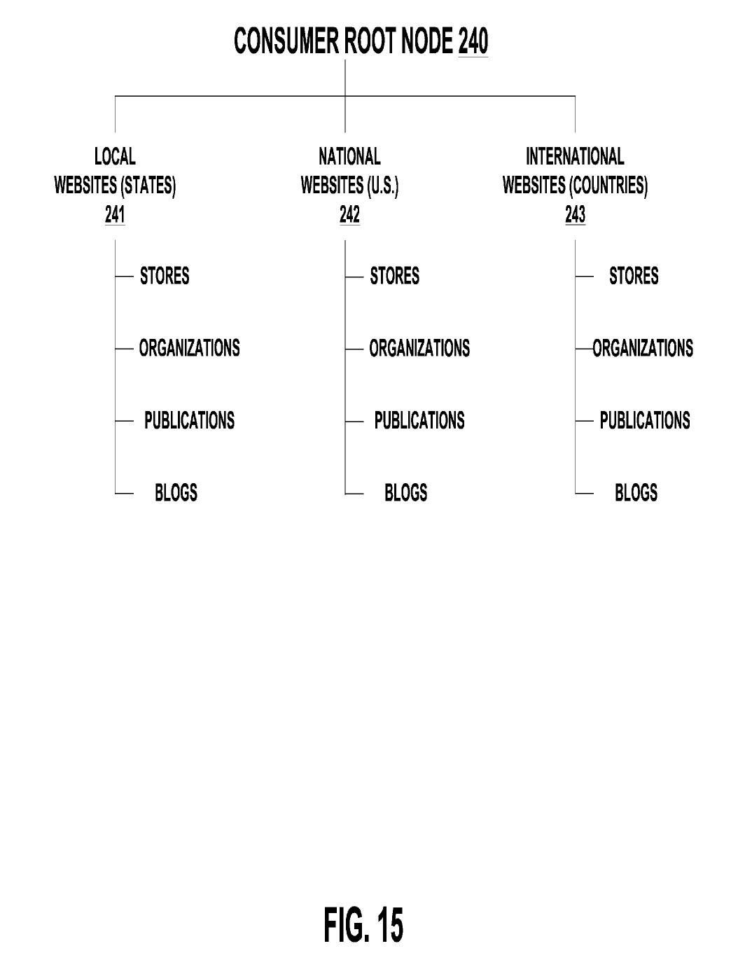

A consumer root node 240 lists all websites primarily designed for the on-line sale of products and services from various sources (e.g., stores, organizations, publications and blogs) and may be further branched into local websites node 241, national websites node 242 and international websites node 243 as shown in FIG. 15. An example includes, but is not limited to, www.dell.com listed under television for national website node 242.

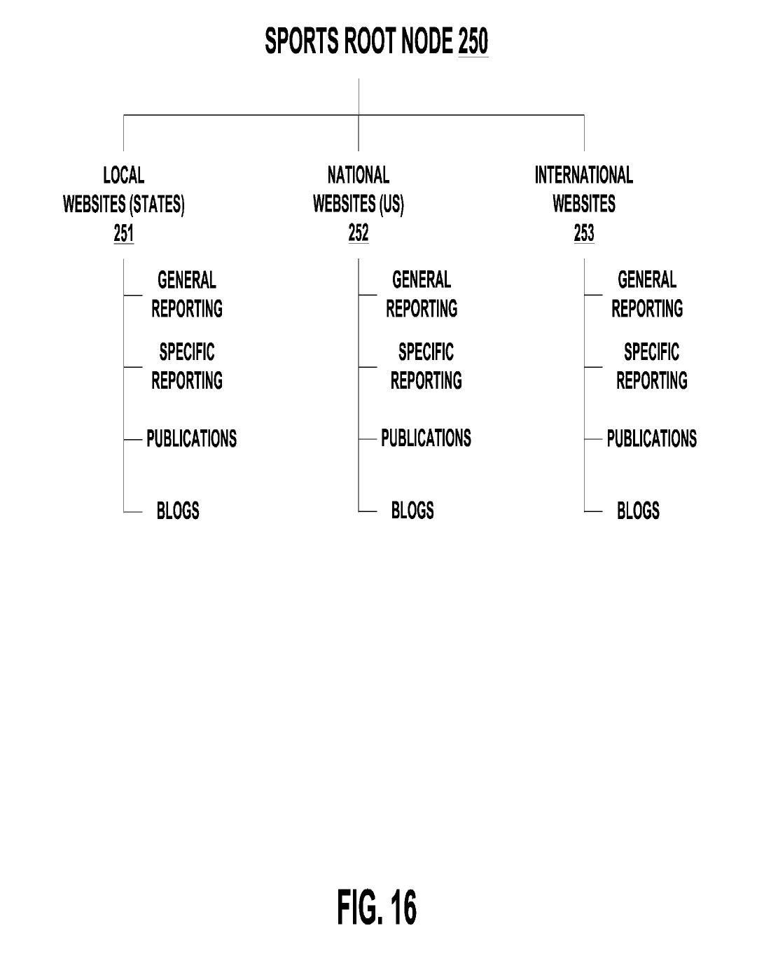

A sports root node 250 lists all websites primarily designed for the reporting of sports information from various sources (e.g., general sports reporting, specific sports reporting, publications and blogs) and may be further branched into local websites node 251, national websites node 252 and international websites node 253 as shown in FIG. 16. An example includes, but is not limited to, www.espn.com listed under national website node 252.

A video root node 260 lists all websites primarily designed for the viewing of videos from public sources or privates sources. An example includes, but is not limited to, www.youtube.com.

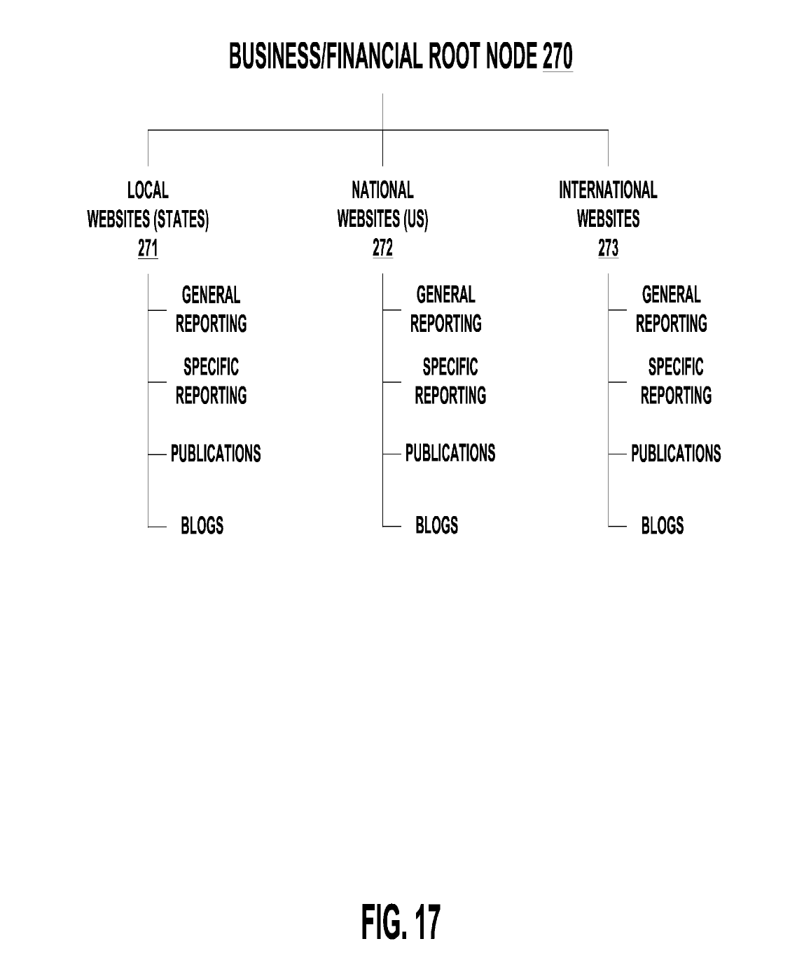

A business/financial root node 270 lists all websites primarily designed for the reporting of business/financial information from various sources (e.g., general business/financial reporting, specific business/financial reporting, publications and blogs) and may be further branched into local websites node 271, national websites node 272 and international websites node 273 as shown in FIG. 17. An example includes, but is not limited to, www.wsj.com listed under national website node 272.

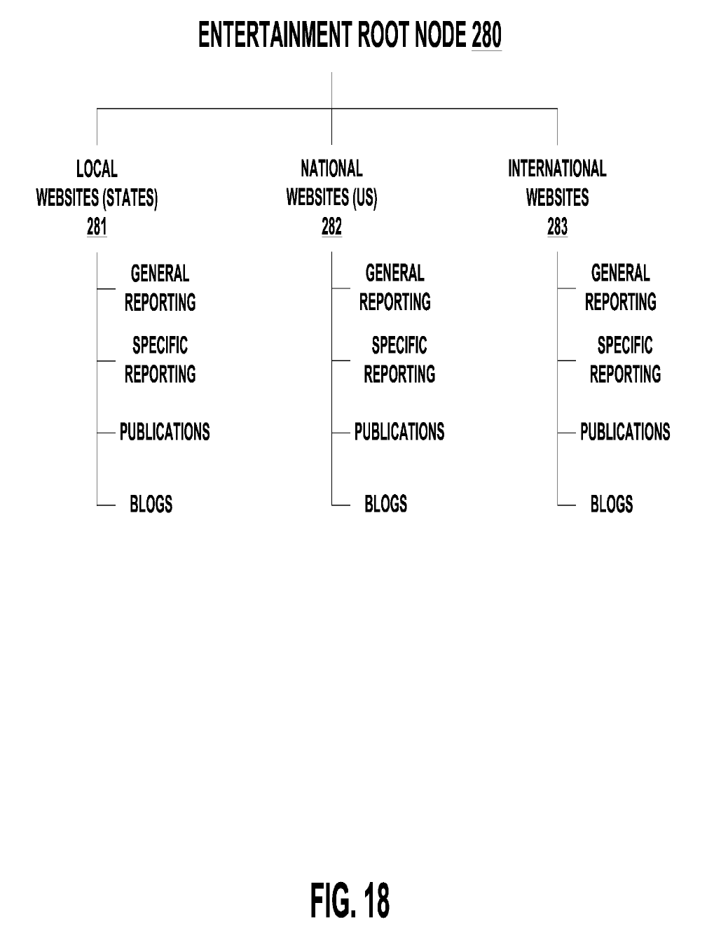

An entertainment root node 280 lists all websites primarily designed for the reporting of entertainment information from various sources (e.g., general entertainment reporting, specific entertainment reporting, publications and blogs) and may be further branched into local websites node 281, national websites node 282 and international websites node 283 as shown in FIG. 18. An example includes, but is not limited to, www.tmz.com listed under national website node 282.

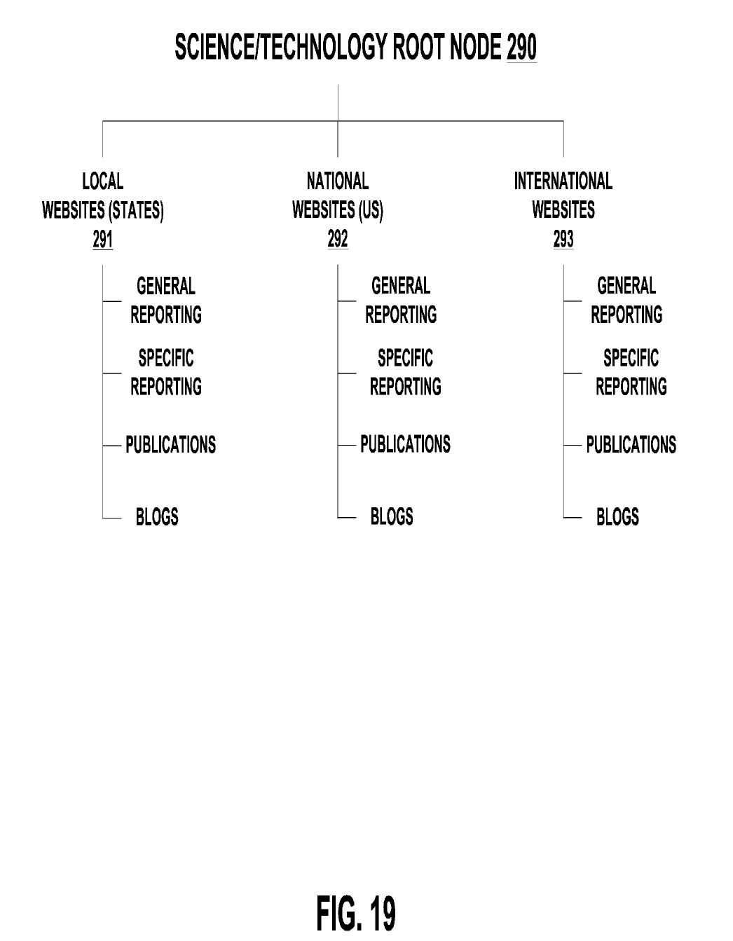

A science/technology root node 290 lists all websites primarily designed for the reporting of scientific and technological information from various sources (e.g., general science/technology reporting, specific science/technology reporting, publications and blogs) and may be further branched into local websites node 291, national websites node 292 and international websites node 293 as shown in FIG. 19. An example includes, but is not limited to, www.space.com listed for national website node 292.

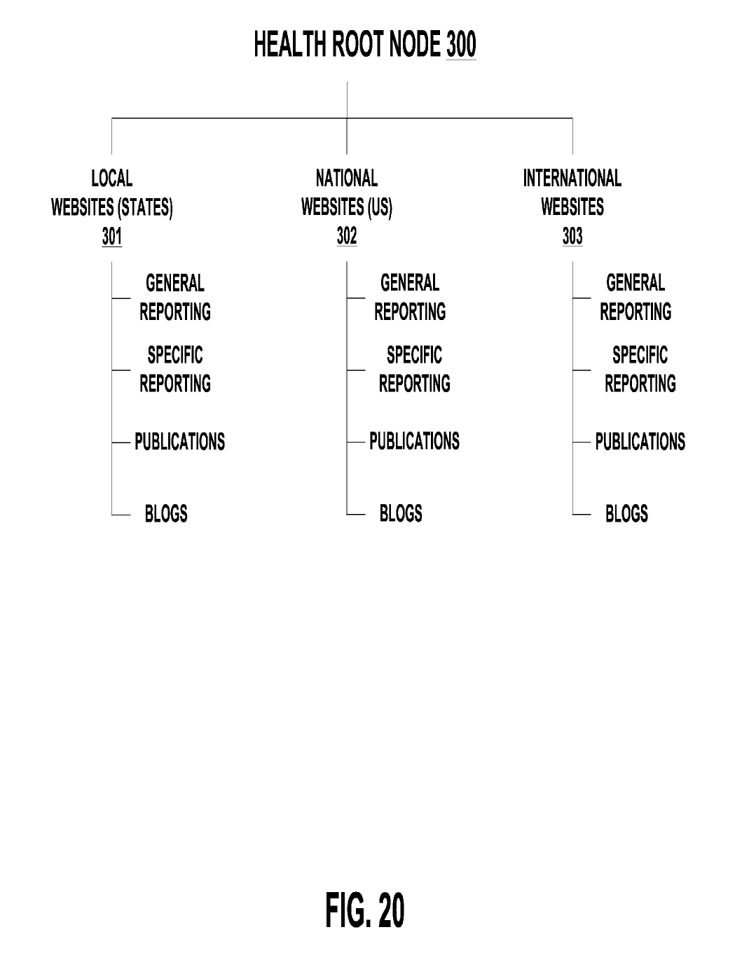

A health root node 300 lists all websites primarily designed for the reporting of health information from various sources (e.g., general health reporting, specific health reporting, publications and blogs) and may be further branched into local websites 301, national websites 302 and international websites 303 as shown in FIG. 20. An example includes, but is not limited to, www.webmd.com listed under national website node 302.

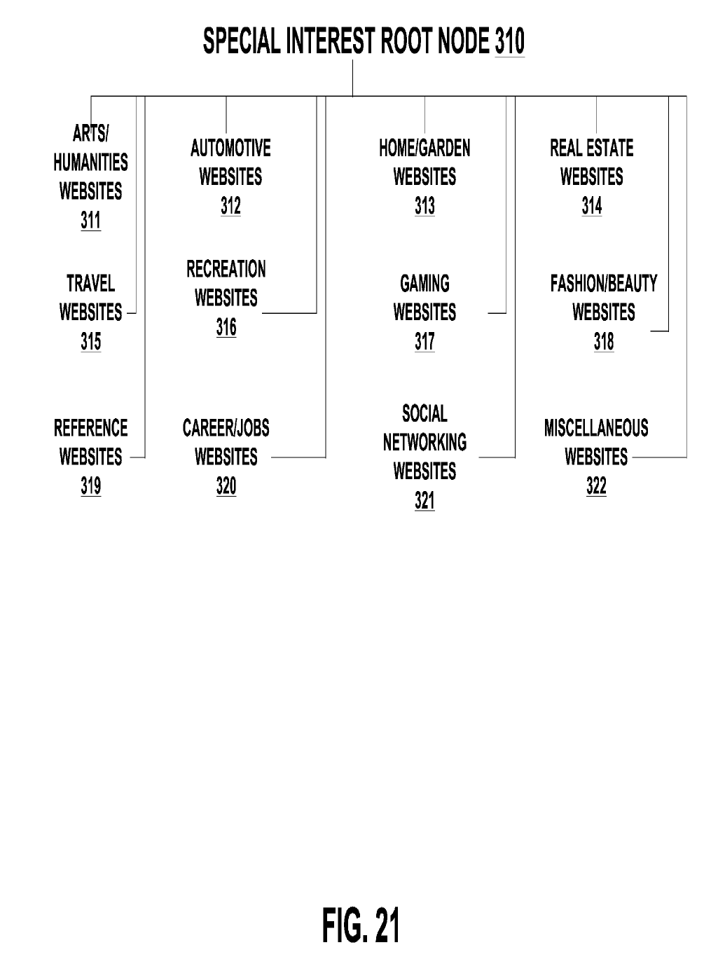

A special interest root node 310 lists all websites primarily designed for a particular interest from various sources, and may be further branched into arts/humanities websites 311, automotive websites 312, home/garden websites 313, real estate websites 314, travel websites 315, recreation websites 316, gaming websites 317, fashion/beauty websites 318, reference websites 319, career/job websites 320, social networking websites 321 and miscellaneous websites 322 as shown in FIG. 21.

A personal root node 330 lists all websites primarily designed for a selective group for a particular purpose, such as, for example, each website having a personal login to view web feed content.

In practice, website library server 141 may employ website genre tree 100 for each user of system 140 as a public library and may allow for a modification of website genre tree 100 to some extent by users to form private libraries.

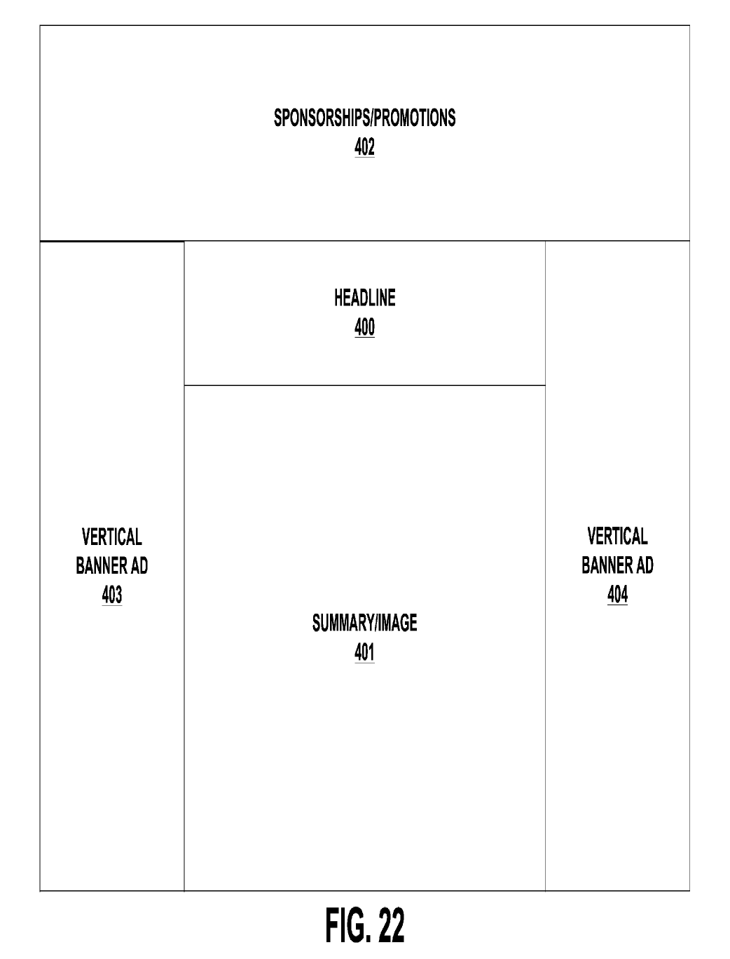

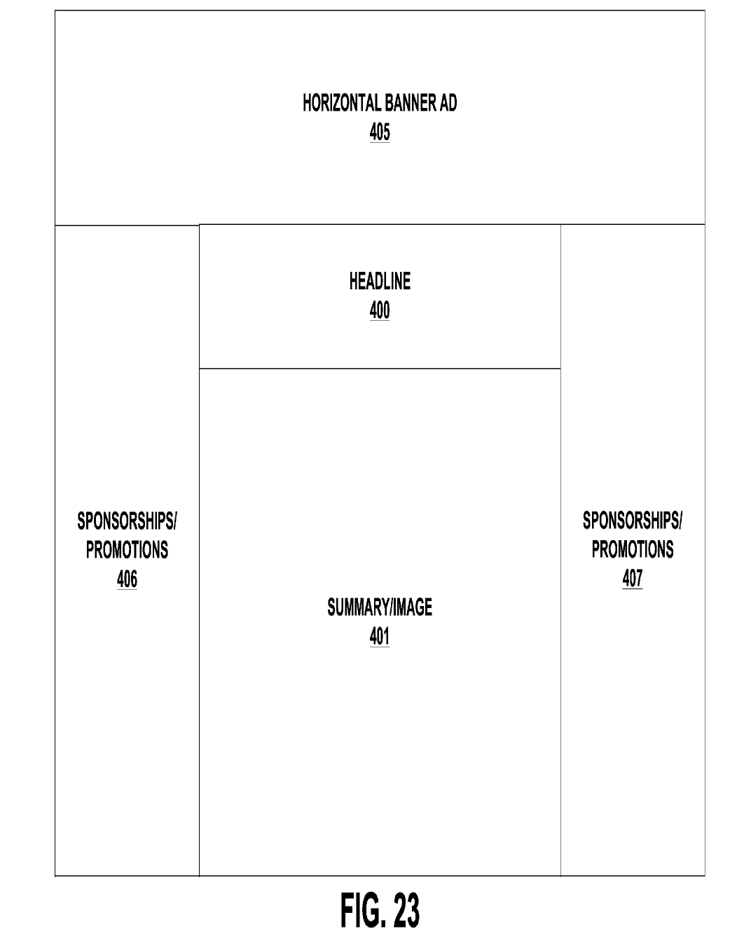

Referring back to FIG. 8, bulletin reader server 142 is structurally configured to create a bulletin for each web feed item in accordance with each website node of web genre tree 200. Each bulletin will have a headline and summary/image derived from the web feed item (e.g., RSS feed), such as, for example, headline 400 and summary/image 401 shown in FIGS. 22 and 23. Optionally, each bulletin may include banner ads and/or sponsorships/promotions, such as, for example, sponsorships/promotions 402 and banner ads 403/404 shown in FIG. 22, and banner ad 405 and sponsorships/promotions 406/407 shown in FIG. 23.

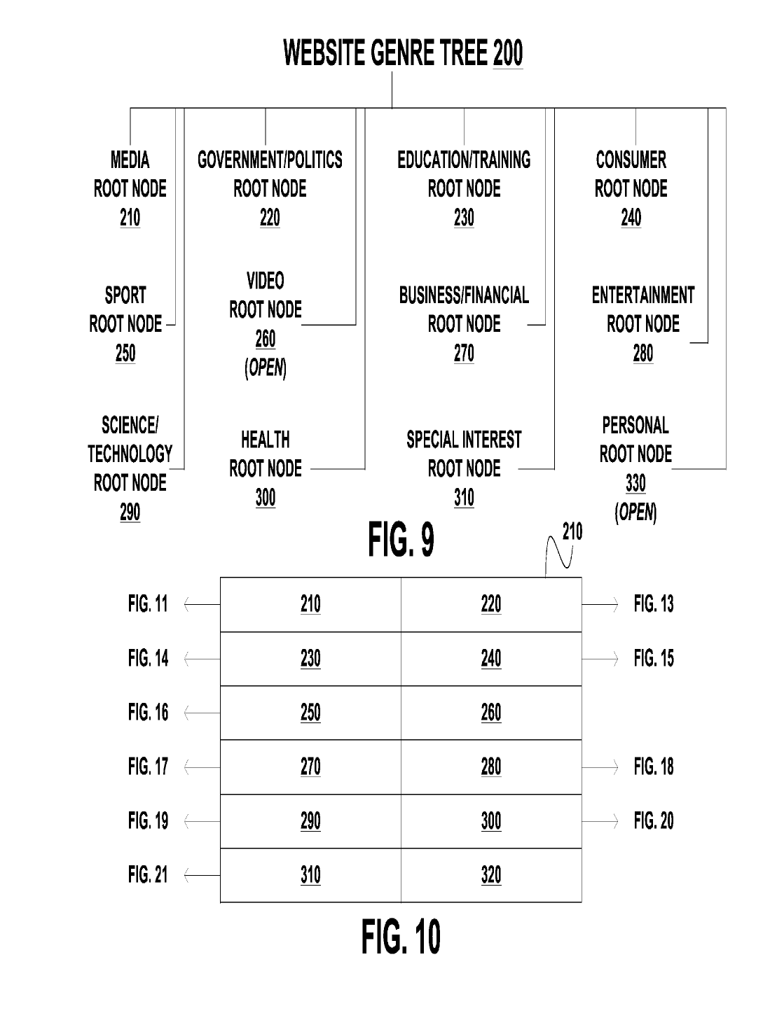

For management and display purposes, website genre tree 200 may be organized in a manner that facilitates navigation within tree 200 via a mouse or a remote control, such as, for example, a page 210 shown in FIG. 10.

An exemplary display navigation system as shown in FIG. 11 involves navigation through media root node 210. Specifically, as shown, sequential selection via a mouse or remote control of local websites node 211 to television websites node 211(A) to channel 6 website 211(A)(1) to headlines RSS feeds 211(A)(1)(a) results in channel 6 bulletins for display.

Referring back to FIG. 8, database server 143 is structurally configured to manage all necessary database tables for the account association as well as facilitating a management and a display of webs feed content. For example, database server 143 may store profile tables for the account association as well as any other pertinent user information (e.g., login). Further, database server 143 may store website node tables for associated bulletins being generated by server 141. Database server 143 may also include any relational tables as needed.

Still referring to FIG. 8, website server 150 is structurally configured to facilitate a user selection of subscriptions to web feeds of various websites in accordance with a scripted navigation through the website genre tree. Website server 150 is further structurally configured to facilitate a user search of one or more terms within the headlines and summary of each bulletin or specific set or sets of bulletins.

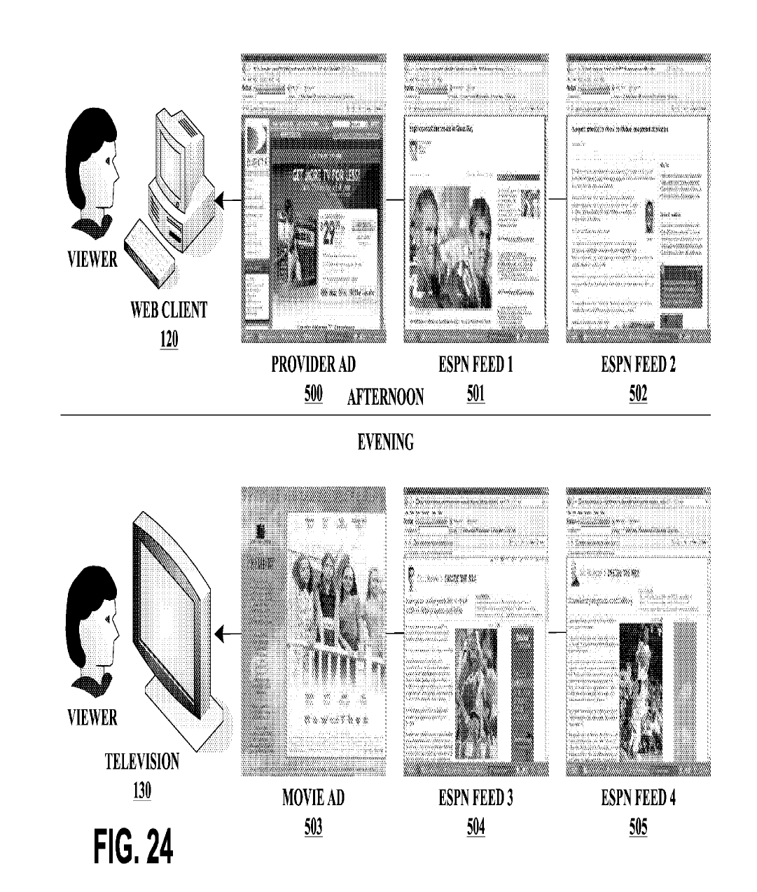

Both website server 150 and TV site 160 are structurally configured to facilitate a synchronized content display of journals for website subscriptions, topics for results of term searching, previews of unsubscribed websites and chronicles of links to saved bulletins. An example of a synchronized viewing is shown in FIG. 24. Specifically, a viewer may view a journal display or topic display of feeds 501 and 502 that were syndicated by www.espn.com in the morning of a particular day, and a journal display or topic display of feeds 503 and 504 that were syndicated by www.espn.com in the evening of that day. In this example, the viewer is presented with feeds 501 and 502 in the afternoon via web client 120 and then presented with feeds 503 and 504 in the evening via television 130. This ensures new feeds are also presented first with each viewing.

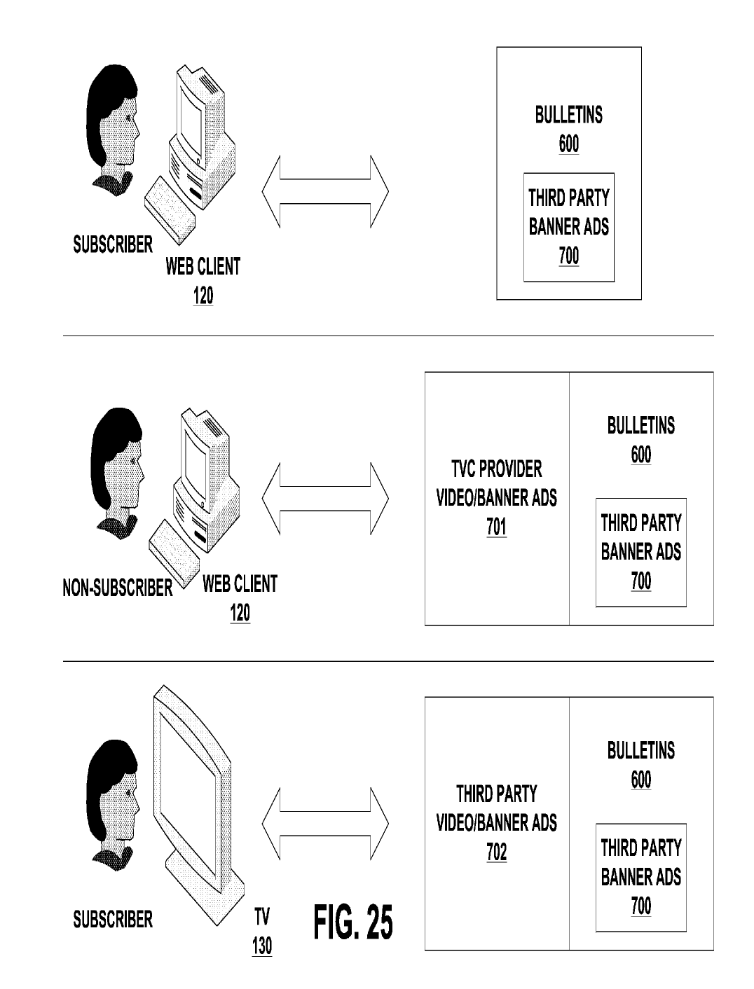

Ads 500 and 501 shown in FIG. 24 highlight various advertising schemes as shown in FIG. 25 for a subscriber of the television content. Specifically, a subscriber/web client 120 scheme involves the subscriber viewing third party banner ads 700 relative to bulletins 600. A nonsubscriber/web client 120 scheme involves the nonsubscriber first viewing a television content provider video advertisement/promotion 701 and followed by third party banner ads 700 relative to bulletins 600. A subscriber/television 130 scheme involves the subscriber first viewing a third party video advertisement/promotion 702 and followed by third party banner ads 700 relative to bulletins 600.

As known in the art, servers include processors and memories. For the purposes of the present invention, the term “processor” as used herein is broadly defined as one or more processing units of any type for performing all arithmetic and logical operations and for decoding and executing all instructions related to facilitating an implementation of the present invention. Additionally, the term “memory” as used herein is broadly defined as encompassing any and all program and data storage in the form of computer readable mediums of any type.

While the embodiments of the invention disclosed herein are presently considered to be preferred, various changes and modifications can be made without departing from the spirit and scope of the present invention. The scope of the invention is indicated in the appended claims, and all changes that come within the meaning and range of equivalents are intended to be embraced therein.

What is claimed is:

1. A method of displaying web feed content on television, the method comprising:
operating a web feed content aggregation system for retrieving syndicated web feed content on a web subscription basis,
wherein the web feed content aggregation system includes a library organized in a web genre tree format including a root node branching to at least one website node,
wherein each one website node lists at least one website corresponding to a genre of the root node, and
wherein each website lists at least one web feed;
operating a television content broadcast system for broadcasting television content on a television subscription basis;
interfacing the web feed content aggregation system and the television content broadcast system based on an account association of a web feed content aggregation subscription account and a television content broadcast subscription account; and
facilitating a user management of a television display of the web feed content as a function of the account association of the web feed content aggregation subscription account and the television content broadcast subscription account.

2. The method of claim 1, wherein the library is a public library.

3. The method of claim 1, wherein the library is a private library derived from the public library.

4. The method of claim 1, wherein the library is a private library derived from an alternative web feed content aggregation system.

5. The method of claim 1, further comprising:
generating a plurality of web feed bulletins, each web feed bulletin providing a report of a single web feed item.

6. The method of claim 5, wherein each web feed bulletin reports at least one of a headline, a summary and an image associated with the single web feed item.

7. The method of claim 5, further comprising:
providing a journal display of at least one web feed bulletin associated with at least one website subscription within the web feed content aggregation subscription account.

8. The method of claim 5, further comprising:
providing a topic display of results of a search of at least one web feed bulletin in accordance with at least one search term associated with the web feed content aggregation subscription account.

9. The method of claim 5, further comprising:
providing a preview display of at least one web feed bulletin unassociated with each website subscription within the web feed content aggregation subscription account.

10. The method of claim 5, further comprising:
providing a chronicle display of a user-recording of at least one web feed bulletin.
